(19) United States
(12) Patent Application Publication
(10) Pub. No.: US 2007/0010254 A1
(43) Pub. Date: Jan. 11, 2007

(54) System and method for access to fixed mobile communications

(76) Inventors: Keith G. Regan, Ellicott City, MD (US); Ashutosh Singh, Herndon, VA (US); Ana Regan, Ellicott City, MD (US)

Correspondence Address: Bell, Boyd & Lloyd LLC, P.O. Box 1135, Chicago, IL, 60690-1135, US

(21) Appl. No.: 11/118,891

(22) Filed: Apr. 28, 2005

(51) Int. Cl. H04Q 7/20

(52) U.S. Cl. 455/445

(57) ABSTRACT

The present disclosure provides a system and method for routing calls within a telecommunication system, wherein a call dialed by a user is received and processed, without relying on location registers, for routing the call within the telecommunications system. Once processed the call is simultaneously transmitted the to a plurality of geographical regions. Under an alternate embodiment, a bearer type is analyzed to determine the type of call being made. In accordance with the bearer type, calls are routed to one or more terminals associated with a respective bearer type.

### FIELD OF TECHNOLOGY

This disclosure relates generally to a system for completing calls to mobile telephones, more particularly to satellite telephone communication, and, more specifically, to a system for delivering calls to mobile terminals as the terminals move from region to region.

### BACKGROUND

Many mobile telephone systems operate using technology that allows calls to be transmitted and received from any point in the world. An example of this technology is the International Maritime Satellite (“Inmarsat”) system, which is a partnership of numerous countries that manage global communications to and from terminals located on the land, sea or air. Because wireless communication is generally line-of-sight and, thus, limited by the earth's curvature, Inmarsat uses satellites to provide wireless connection between any two points on the earth. Each of the Inmarsat satellites cover a predefined “region” or area of coverage. Under this system, an Inmarsat customer may be reached from anywhere in the world, provided the calling party knows the region in which the Inmarsat customer is located.

In order to call an Inmarsat subscriber, a person dials the international country code(s) as assigned to Inmarsat by the ITU-T, the service code (SC), then a 6-9-digit call identification number. The Inmarsat system divides the world into four regions, each of which is designated by country codes, 871, 872, 873 and 874. Each of these country codes are associated with their respective Inmarsat regions, namely: Atlantic Ocean Region-East (871), Atlantic Ocean Region-West (874), Pacific Ocean Region (872), and Indian Ocean Region (873). The caller has to typically dial the correct Inmarsat country code of the region where the called ship is located, otherwise the call cannot be completed.

To insure that all calls can be completed to remote terminals requires a database for keeping track of the location of each ship. Such a database could be a collection of interconnected databases, one local to each switch in the Inmarsat system, or it may be one common database which serves all switches worldwide. The location of each terminal would be contained in the database, which location would be updated periodically.

FIG. 1 provides an illustration of the Inmarsat telephone system 100. As mentioned previously, the Inmarsat system, divides the world into four ocean regions: Atlantic Ocean Region-East 101 (e.g., 871), Pacific Ocean Region 102 (e.g., 872), Indian Ocean Region 103 (e.g., 873), and Atlantic Ocean Region-West 104 (e.g., 874). Calls to and from each region are made through its own satellite, i.e., satellites 105-108, which are in geostationary orbit. Each satellite is in communication with several ground-earth stations represented in FIG. 1 by (GES) 1-4, which provide the land-to-satellite link to other communications systems, and vice versa. The GES's would deploy a series of gateway switch(s) 121, to communicate with a PSTN as well as with each other. These gateway switches generally allow for communication services to be routed from the GES to different countries or for calls from different countries to be routed to an Inmarsat terminal (109-116) that is currently using the satellite, as seen by that GES. For incoming calls from the PSTN to country code(s) 871-874, the gateway switch 121 would route the call to a selected GES 1-4, depending upon the dialed country code. The selected GES then uplinks to its corresponding satellite 1-4. Each satellite then transmits call information to/from the terminals (109-116) associated with that satellite

The GES's of FIG. 1 are geographically located in each region to provide the best coverage to a particular Inmarsat satellite that can be seen from a particular location (latitude/longitude). A specific GES may provide coverage for up to three Inmarsat satellites in geo-stationary orbit. Typically a GES will provide coverage for one to two Inmarsat satellites. In addition to providing satellite coverage, the GES's are also interconnected to terrestrial communication networks (public switched telephone network (PSTN), public internet, etc.), via gateway switches. These gateway switches allow users of the PSTN network to access the satellite network and vice versa. Through its gateway switch, each GES has an agreement with various national and international PSTN carriers to route Inmarsat calls (e.g., country code 871, 872, 873 and 874) through that particular GES and to also terminate PSTN calls from Inmarsat satellite terminals using that GES. The PSTN carriers would thus route a call to country code 871 to a particular GES, while 872 would be routed to a different GES.

Based upon this criteria of providing coverage and communication services for the individual Inmarsat satellites, each GES is identified with the PSTN network as providing the termination services for one or more of the Inmarsat country codes. Thus, the GES's are configured such that GES 1 serves satellite 105 and is assigned the country code 871; GES 2 serves satellite 106 and is assigned the country code 872, GES 3 serves satellite 107 and is assigned the country code 873, and GES 4 serves satellite 108 and is assigned the country code 874 by the PSTN carriers for routing purposes.

When the user of telephone 123 wants to communicate with telephone terminal 110, the user dials the country code for the region in which the terminal is supposed to be located. In this example, the terminal is shown in the Inmarsat Atlantic Ocean Region-West, which has an country code of 874. Accordingly, the user of telephone 123, dials an international PSTN call with country code 874, then the service code (SC), then a 6-9 digit terminal number. This connection attempt is passed through telephone network 122, which recognizes Inmarsat country code 874, forwards the call to gateway switch 121. In response to the country code 874, gateway switch 121 routes the call to GES 4, which in turn attempts the call through satellite 108. If terminal 110 is in Atlantic Ocean Region-West 104 (as shown in FIG. 1 in phantom), then it will receive the call, and the call is completed.

One problem that exists in the art is that the process of placing calls requires the routing architecture to be overly reliant on location registers for placing calls. Furthermore, the reliance on location registers forces most systems into using serial processes for completing calls. This problem is especially pronounced when the actual location of the receiving terminal is not known.

FIG. 2 provides an example of a call initiated by a user to reach an end terminal whose location is unknown at the time a call is made. The process begins at 200, where a switch initiates a first call to a region associated with a first country code (874), where a determination is made in 201 whether or not a connection is established. If a connection exists, the call is connected to the region via country code 874. If the connection does not exist (i.e., the remote terminal does not answer), the switch attempts to retry the call 203 to a different region serviced by the next associated country code (871). Again, the switch initiates a call to the next country code 204, determines if a connection is made 205 and connects the call 206 if the terminal is answered. If it is not answered, the switch attempts to retry the call 207 to a different region serviced by the next associated country code (872). This process is repeated for the remaining country codes (shown in FIG. 2 as 208-214) until the terminal answers. If there still remains no answer, the switch signals that the terminal is not logged on to the network 215.

Since each access code is queried sequentially, and since caller location is dependent on the location registers stored within the Inmarsat system, placing calls to terminals of unknown location unnecessarily burdens the system. This problem becomes even more aggravated in cases where Inmarsat-Aero (aviation communications) and Inmarst-A calls do not have reliable location information where systems can locate the addressed satellite mobile unit prior to routing the call. Accordingly, there remains a need in the art for establishing telecommunication connections where remote terminal location is not precisely known.

Furthermore, since many subscribers have to specify different numbers for different services handled by the telecommunication system (e.g., voice, fax, data), there is a need to provide integrated services where all types of services can be routed to a called party using a single access number.

### SUMMARY

In one aspect, the present disclosure teaches a telecommunication system that, instead of relying on location registers, the system simultaneously initiates multiple calls at the same time towards all ocean regions. Under an exemplary embodiment discussed below, each satellite terminal is assigned a phone number associated with the national numbering plan of a given country. Within that country, the national phone number is routed to the service provider, where the national number is translated into an Inmarsat international number, or to other non-Inmarsat numbers, such as VSAT (very small aperture terminal).

When telecommunication transmissions are initiated from a terminal, the message emanating from the terminal identifies a bearer type, which also may specify a requested service, mode of transmission (packet or circuit), data rate and type of information content. Another aspect of the present disclosure teaches a telecommunication system wherein the bearer type of a incoming call is used to map the national number to an internal number that is routed within a network. As an example, voice calls (bearer 1) would be routed differently from data calls (bearer 4).

These and other features and advantages of the invention will be more apparent from the following detailed description that is provided in connection with the accompanying drawings and illustrate exemplary embodiments of the invention.

### BRIEF DESCRIPTION OF THE DRAWINGS

FIG. 1 is a system view of a prior art Inmarsat system communicating within numerous regions;

FIG. 2 is a flow chart illustrating an attempt made through a switch to transmit to a remote Inmarsat terminal according to the prior art;

FIG. 3 illustrates an exemplary telecommunication system under a first embodiment;

FIG. 4 is an exemplary flowchart illustrating the analysis of the bearer type under an alternate embodiment;

FIG. 5 is an exemplary translation table for routing calls according to detected bearer types; and

FIG. 6 is a flowchart illustrating an exemplary routing process under the embodiment described in FIGS. 4-5.

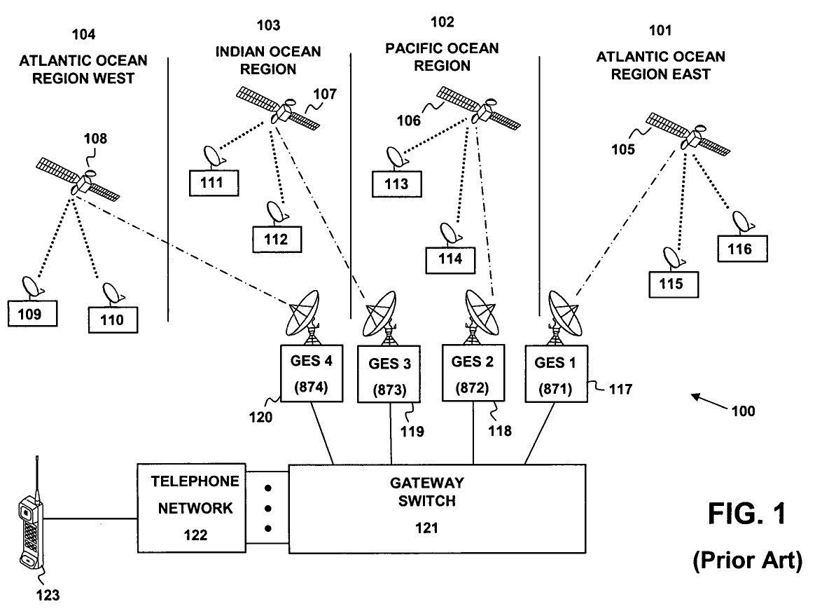

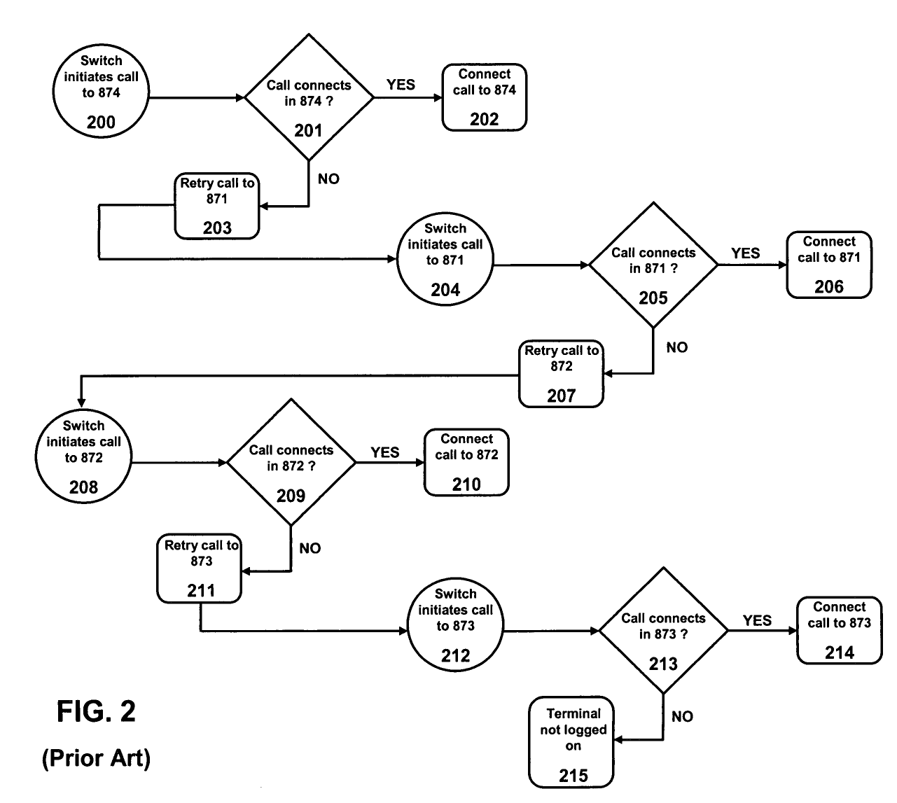

### DETAILED DESCRIPTION

In the following detailed description, reference is made to the accompanying drawings, which form a part hereof, and in which is shown by way, of illustration of specific embodiments in which the invention may be practiced. These embodiments are described in sufficient detail to enable those skilled in the art to practice the invention, and it is to be understood that other embodiments may be utilized, and that structural, logical and electrical changes may be made without departing from the spirit and scope of the present invention.

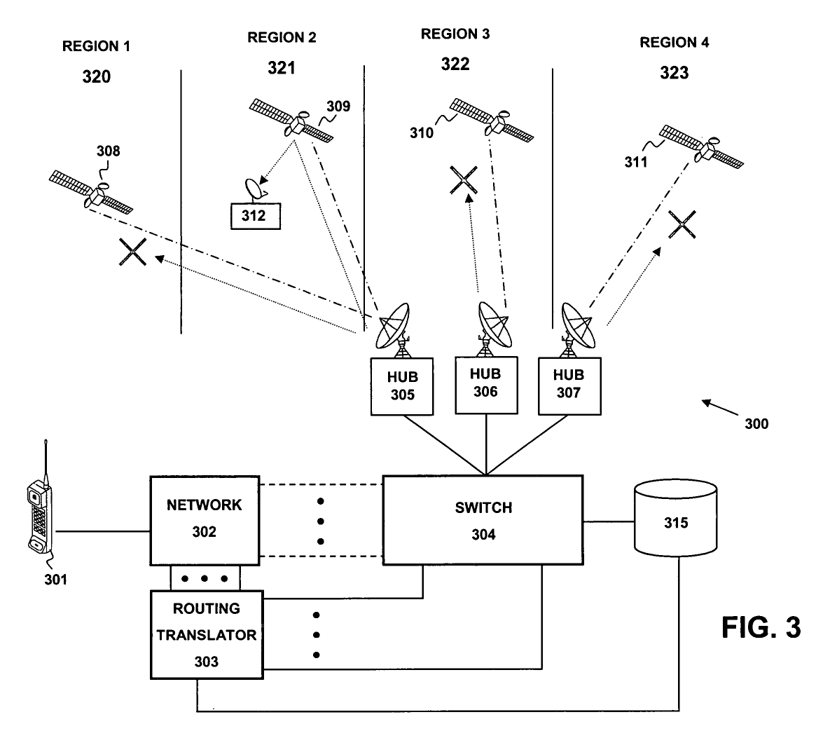

FIG. 3 illustrates an exemplary telecommunications system 300, where a subscriber 312 is configured to receive communications from a caller 301 via network interface 302. Network 302 may be any circuit-switched or packet-switched network, or some combination of both. The terminal assigned to subscriber 312 is assigned a telephone number in accordance with national numbering plans (e.g., 310-555-1212) of a given country. The blocks of these numbers for each state/region under a preferred embodiment are stored in memory 315, which is operatively coupled to switch 304 and routing translator 303. Memory 315 also contains international numbers or Inmarsat numbers used for translating.

When a call is made to switch 304, the national number is routed from terminal 301, through network 302, to routing translator 303 for processing. Routing translator 303 converts and maps the national number to a second number, such as an Inmarsat international number. While routing translator 303 is illustrated as a separate entity, it is understood that translator 303 may be integrated into other elements, such as switch 304. Further details of the converting/mapping processing performed by routing translator 303 under an alternate embodiment is discussed below. Alternately, the Inmarsat international number may be directly dialed from terminal 301 to switch 304 via network 302, thus bypassing the converting/mapping operation. It should be understood that while the embodiments disclosed herein are discussed in the context of Inmarsat communication, other types of communication systems and protocols (e.g., VSAT) are equally applicable without deviating from the spirit and scope of the invention.

Once the Inmarsat international number is mapped, an incoming call is simultaneously set up towards all regions in which may operate a mobile satellite communications unit, such as an aircraft, a ship, a vehicle, or land. Under the present embodiment, location databases are not exclusively relied upon to narrow routing selection; so calls are placed simultaneously to all regions all at once. To control the routing of these calls, entered numbers are mapped using the same nationally significant components of the dialed number, and different country codes are appended to the call to reach a desired destination regions. For example, under an Inmarsat call configuration, the appended country codes would correspond to the ocean regions (discussed above) in which the satellite unit may be operating. Other types of routing codes (e.g., iDirect) can be used as well. The dialed numbers and routing codes are subsequently sent to hubs 305-306 for simultaneous transmission and satellite linking to satellites (320-323) servicing different regions.

The above configuration is particularly advantageous in cases where Inmarstat-Aero and Inmarstat-A calls are being made, where neither configuration has reliable location information that can be used to locate an addressed satellite mobile unit prior to routing the call. Accordingly, the exemplary embodiment sets up simultaneous calls to negate the effect of unreliable location registers. In contrast, Inmarsat calls such as M/B/mM, have reliable location register for each satellite mobile unit. This register is an integral part of the M/B/mM network. Accordingly. this information is used to route a call to an appropriate hub or ocean region using one call instance.

Referring back to FIG. 3, in order to provide the proper linking, hubs 305-307 process the routing code or other identifier when signaled so that each hub will know which satellite unit to contact within the region managed by a hub or hubs. This information is preferably taken from the nationally significant part of the internal number routed within the network. Each hub 305-307 is configured to recognize nationally significant numbers in the system and in turn can determine if the number is active or inactive within the coverage area of the hub. For inactive numbers, the hub signals back to the originating switch 304 (the one processing the call arriving from the national network) and that particular call is cleared, leaving the other simultaneous calls alone.

In the example illustrated in FIG. 3, hubs 306 and 307 are assigned to their own specific region (Regions 3 and 4 respectively), while hub 305 services Regions 1 and 2. Determining which region(s) are being serviced by specific hubs becomes important when placing simultaneous calls, discussed below, as the number of required calls can be reduced by routing calls to hubs that service multiple regions. Once the simultaneous calls are made to all regions, hubs with inactive numbers clear their calls, until only the one with an active number remains. If no active calls are connected (i.e., the number is inactive globally), the call clears with an “absent” message. However, once an active call is connected, it remains routed to the connecting regional hub, and a connection is provided to the caller once the active number within the region answers. This is illustrated in FIG. 3, where hubs 305-307 simultaneously transmit calls to regions 1, 3 and 4, respectively, wherein no active connections are available. However, region 2, which is also serviced by hub 305, establishes a connection with subscriber 312.

The bearer type is a refinement on the mapping of the national number to an international number routed within the network. As an example, voice calls (bearer 1) can be routed differently from data calls (bearer 4). This is accomplished through management of the bearer type, which indicates whether the call is voice, data, fax, or other types of media. Under an exemplary embodiment, users may connect to three different Inmarsat service types through the same terminal, or across multiple terminals anywhere on the earth by dialing a single telephone number enabled by the service provider. Different Inmartsat service communication bearer types are described in document ITU-T Q.931, with overall network operation being described in ITU-T E.215, both documents of which are incorporated by reference in their entirety herein.

FIG. 4 illustrates an exemplary routing of a call made by a user who is provided with three different Inmarsat services and terminal numbers where each respective service will be routed. Under the example in FIG. 4, the service assigns one number per route for each group of three different bearer types. In step 400, a user call is received on the assigned number. In step 401, the call is analyzed to determine the bearer type specified in the call. In the example provided in FIG. 4, the user has specified three different Inmarsat terminals to receive each respective type of call. It is understood that one or many terminals may be specified for receiving calls under this configuration.

In step 402, if the bearer type is determined as speech, the call is routed to terminal INM1, which, under the example, is designated as the terminal for receiving voice calls. If it is determined that the bearer type is not speech, the process continues to step 404, where it is determined whether a call has a UDI bearer type. If a UDI bearer is detected, the call is routed to terminal INM2 designated to receive UDI calls in step 405. If the call is determined to be a facsimile (3.1 kHz audio) in step 406, the call is routed to INM3 in step 407. If the bearer type cannot be determined, or is not supported within the system, the call ends as is shown in FIG. 4.

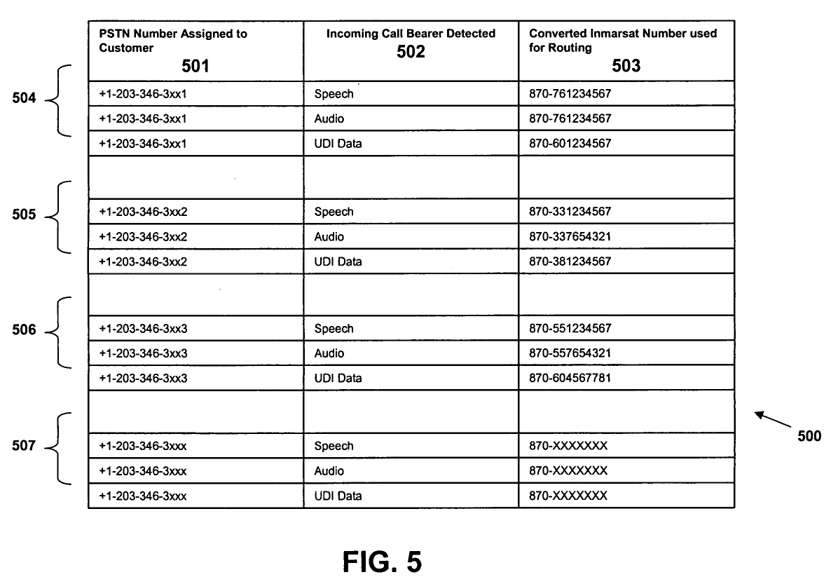

Turning to FIG. 5, an exemplary translation table 500 is illustrated, where the columns of the translation table are organized according to a PSTN number assigned to the customer (501), an incoming call bearer detected (502), and a converted Inmarsat number (503) that is used for the routing. Under a preferred embodiment the incoming call bearer (502) is detected via ISDN or SS7 signaling protocol. It is understood that the translation table 500 of FIG. 5 is one of many different configurations that may be implemented in the routing translator 303 shown in FIG. 3.

Rows 504-507 are occupied by one or more user numbers, as shown in FIG. 5, where each number or numbers have three bearer types (speech, audio and UDI data) and an Inmarsat number to which each bearer type will be routed to.

In row 504, the user is configured in the system such that speech and audio bearer data will route the call to one Inmarsat number (870-761234567), while UDI bearer data will be routed to a second Inmarsat number (870-601234567). In the examples of 505 and 506, users are configured to use each type of bearer data to route calls to different Inmarsat numbers. As the example in 507 shows, the call bearer data may be configured any way that is convenient to the user to allow different types of calls to be routed to different Inmarsat numbers or machines.

FIG. 6 provides an additional example where a customer dials a PSTN number assigned to a user (600). When the call is received in the network, the incoming call is examined (601) to establish the bearer type, wherein the routing is set up in accordance with the translation table (500) in step 602. The translation table then provides the translated number 603 that is subsequently routed to a respective Inmarsat number 604. Subsequent calls may then be executed either in a conventional fashion or may also be executed in accordance with the embodiment disclosed in FIG. 3, where all Inmarsat (Aero) hubs are called simultaneously.

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

1. A method for routing calls within a telecommunication system, comprising:
receiving a call dialed by a user;
processing the call, without relying on location registers, for routing within the system; and
simultaneously transmitting the processed call to a plurality of geographical regions.

2. The method according to claim 1, wherein the received call is dialed in accordance with a national numbering system.

3. The method according to claim 2, wherein the step of processing the call comprises mapping the received call to a plurality of international numbers, each of which are associated with a respective geographical region.

4. The method according to claim 3, wherein the international number is an Inmarsat number, and said geographical regions are ocean regions.

5. The method according to claim 1, further comprising monitoring each of the simultaneously transmitted calls for a predetermined period of time, wherein calls are dropped if the call is not answered within the predetermined period of time.

6. A system for routing calls within a telecommunication system, comprising:
a network interface for receiving a call dialed by a user;
a routing translator, operatively coupled to the network interface, for processing the call without relying on location registers to determine a plurality of routing paths within the system; and
a telecommunication switch, operatively coupled to the routing translator, for simultaneously transmitting the processed call to a plurality of geographical regions.

7. The system according to claim 6, wherein the received call is dialed in accordance with a national numbering system.

8. The system according to claim 7, wherein the routing translator maps the received call to a plurality of international numbers, each of which are associated with a respective geographical region.

9. The system according to claim 8, wherein the international number is an Inmarsat number, and said geographical regions are ocean regions.

10. The system according to claim 6, wherein the telecommunications switch monitors each of the simultaneously transmitted calls for a predetermined period of time, wherein calls are dropped if the call is not answered within the predetermined period of time.

11. A method for routing calls in a telecommunication system, comprising:
receiving an incoming call destined to a first predetermined number, wherein the call contains bearer information;
processing the bearer information determine a bearer type;
specifying a routing path to a pre-assigned destination in accordance with the determined bearer type; and
converting said first predetermined number to a second predetermined number associated with the pre-assigned destination.

12. The method according to claim 11, wherein the bearer type is determined in accordance with an ISDN or SS7 signaling protocol.

13. The method according to claim 11, further comprising transmitting the incoming call to the second predetermined number.

14. The method according to claim 13, wherein the first predetermined number is a PSTN number and the second predetermined number is an Inmarsat number.

15. The method according to claim 14, wherein the Inmarsat number is transmitted simultaneously to a plurality of geographical regions.

16. The method according to claim 15, wherein the geographical regions are ocean regions.

17. The method according to claim 11, wherein the routing path is specified according to a translation table.

18. The method according to claim 11, wherein the second predetermined number is different for different bearer types.
